(19) United States
(12) Patent Application Publication
(10) Pub. No.: US 2025/0264439 A1
(43) Pub. Date: Aug. 21, 2025

(54) CHEMICAL COMPOSITION ANALYSIS SPECTROMETER BASED ON LIQUID FRICTION AND ANALYTICAL METHOD THEREOF

(71) Applicant: BEIJING INSTITUTE OF NANOENERGY AND NANOSYSTEMS, Beijing (CN)

(72) Inventors: Shiquan Lin, Beijing (CN); Jinyang Zhang, Beijing (CN); Zhonglin Wang, Atlanta, GA (US)

(21) Appl. No.: 19/201,305

(22) Filed: May 7, 2025

Related U.S. Application Data
(63) Continuation of application No. PCT/CN2023/108850, filed on Jul. 24, 2023.

(30) Foreign Application Priority Data
Apr. 17, 2023 (CN) 202310408963.4

(51) Int. Cl. G01N 27/60

(52) U.S. Cl. CPC G01N 27/60

(57) ABSTRACT

A chemical composition analysis spectrometer based on liquid friction and analysis method thereof, the spectrometer includes a plurality of electrodes arranged in an array, at least one layer of insulating film disposed over the plurality of electrodes, a current collection module, and a data processing module. The current collection module is configured to collect ground current data generated by each of the electrodes. The data processing module is configured to: (a) determine the triboelectric charge amount of the liquid droplet, and generate a position-charge quantity response curve; (b) obtain multiple corresponding spectrum matching degrees; and (c) identify a solution sample in the database with the highest spectrum matching degree, and determine chemical composition, ion species, chemical valence state, and concentration information of the liquid droplet. The spectrometer offers the advantages of a simple structure, low usage costs, portability and ease of maintenance.

### FIELD OF THE INVENTION

The present invention relates to technical field of chemical technology, and more particularly to a chemical composition analysis spectrometer based on liquid friction and analysis method thereof.

### BACKGROUND OF THE INVENTION

Current chemical composition analysis technologies include an inductive coupled plasma emission spectrometer (ICP), an X-ray photoelectron spectrometer (XPS), and ion chromatography (IC). Among these, ICP utilizes the fact that different elements release different amounts of energy during electron transitions, thereby producing their inherent characteristic spectral lines. Simultaneously, the intensity of the spectral lines is related to the atomic density, and by measuring the intensity of the characteristic spectral lines and comparing them with a series of standard solutions of known concentrations, the content of each element in the sample solution can be determined. IC is a liquid chromatography technique that separates and detects substances based on their ionic properties. XPS irradiates the sample surface with X-rays of a certain energy, causing electrons in the sample atoms to be ejected as free electrons, and an energy analyzer is used to measure the energy of the photoelectrons, ultimately obtaining the composition of the sample. Among the three chemical composition analysis technologies mentioned above, ICP and IC are suitable for liquid-phase samples, while XPS is suitable for solid-phase samples. The drawbacks of these three chemical composition analysis technologies are their high equipment costs, difficult maintenance, and lack of portability.

### SUMMARY OF THE INVENTION

Therefore, the object of the present invention is to provide a chemical composition analysis spectrometer based on liquid friction, which has the advantages of a simple structure, low usage costs, portability, and ease of maintenance.

Another object of the present invention provides a chemical composition analysis method based on liquid friction, which is applied to the spectrometer to obtain the advantages of low usage costs, portability, and ease of use.

The present invention provides a filming chemical composition analysis spectrometer based on liquid friction, the spectrometer includes a plurality of electrodes arranged in an array, at least one layer of insulating film disposed over the plurality of electrodes, a current collection module, and a data processing module; wherein, when a liquid droplet to be tested slides on an upper surface of the insulating film along the arrangement direction of the plurality of electrodes, the liquid droplet sequentially generates triboelectric charging with the surface of the insulating film on each of the electrodes, thereby inducing a corresponding ground current in each of the electrodes; the current collection module is configured to collect ground current data generated by each of the electrodes; the data processing module is configured to: (a) determine the triboelectric charge amount of the liquid droplet at different positions on the insulating film along the arrangement direction, based on the arrangement positions of the electrodes and their corresponding ground current data, and generate a position-charge quantity response curve as a measured triboelectric chemical spectrum of the liquid droplet; (b) compare the measured triboelectric chemical spectrum with the standard triboelectric chemical spectra of multiple solution samples in a database, and sequentially obtain multiple corresponding spectrum matching degrees; wherein the multiple solution samples have different chemical compositions, chemical valence states, and/or concentrations; and (c) identify a solution sample in the database with the highest spectrum matching degree to the measured triboelectric chemical spectrum, and determine chemical composition, ion species, chemical valence state, and concentration information of the liquid droplet based on the chemical information of the solution sample.

In the spectrometer of the present invention, each of the electrodes includes a material selected from the group consisting of copper film, aluminum film, and gold film.

In the spectrometer of the present invention, the plurality of electrodes is arranged in a linear array configuration, wherein the orientation of the linear array is inclined relative to a horizontal plane.

In the spectrometer of the present invention, each of the electrodes is characterized by a thickness in a range of 0.1 μm to 1 mm, a length in a range of 1 mm to 100 cm, and a width in a range of 1 mm to 10 cm.

In the spectrometer of the present invention, the width direction of the electrodes is parallel to the direction of the linear array; the plurality of electrodes is arranged in a parallel and equally spaced configuration with a spacing in a range of 1 mm to 100 cm.

In the spectrometer of the present invention, each of the electrodes has a cross-sectional shape perpendicular to the direction of the linear array, wherein the cross-sectional shape is one of a rectangle, a “V” shape, a “U” shape, and a circular ring.

In the spectrometer of the present invention, the plurality of electrodes is arranged in a circumferential array configuration and fixed to a roller; the insulating film is disposed on an inner wall of the roller and in contact with the plurality of electrodes.

In the spectrometer of the present invention, the spectrometer further includes a driving member configured to drive the roller to rotate about its central axis.

In the spectrometer of the present invention, the insulating film is formed from one of polytetrafluoroethylene, perfluoroethylene propylene copolymer, nylon, and polymethyl methacrylate, and has a thickness in a range of 1 μm to 1 mm.

The present invention also provides a chemical composition analysis spectrometer based on liquid friction, which includes a plurality of electrodes arranged in an array, at least one layer of insulating film disposed over the plurality of electrodes, a driving member, a current collection module, and a data processing module; wherein, when a liquid droplet to be tested slides on an upper surface of the insulating film along the arrangement direction of the plurality of electrodes, the liquid droplet sequentially generates triboelectric charging with the surface of the insulating film on each of the electrodes, thereby inducing a corresponding ground current in each of the electrodes; the insulating film is disposed on an inner wall of the roller and in contact with the plurality of electrodes; the driving member is configured to drive the roller to rotate about its central axis; the current collection module is configured to collect ground current data generated by each of the electrodes; the data processing module is configured to: (a) determine the triboelectric charge amount of the liquid droplet at different positions on the insulating film along the arrangement direction, based on the arrangement positions of the electrodes and their corresponding ground current data, and generate a position-charge quantity response curve as a measured triboelectric chemical spectrum of the liquid droplet; (b) compare the measured triboelectric chemical spectrum with the standard triboelectric chemical spectra of multiple solution samples in a database, and sequentially obtain multiple corresponding spectrum matching degrees; wherein the multiple solution samples have different chemical compositions, chemical valence states, and/or concentrations; and (c) identify a solution sample in the database with the highest spectrum matching degree to the measured triboelectric chemical spectrum, and determine chemical composition, ion species, chemical valence state, and concentration information of the liquid droplet based on the chemical information of the solution sample.

In the spectrometer of the present invention, the insulating film is formed from one of polytetrafluoroethylene, perfluoroethylene propylene copolymer, nylon, and polymethyl methacrylate, and has a thickness in a range of 1 μm to 1 mm.

In the spectrometer of the present invention, each of the electrodes is characterized by a thickness in a range of 0.1 μm to 1 mm, a length in a range of 1 mm to 100 cm, and a width in a range of 1 mm to 10 cm.

The present invention also provides a chemical composition analysis method based on liquid friction, characterized in that the method is applied to the spectrometer; the analysis method comprises the following steps: S1: acquiring the ground current data generated by each of the electrodes when the liquid droplet slides on the upper surface of the insulating film; S2: determining the triboelectric charge amount of the liquid droplet at different positions on the insulating film along the arrangement direction, based on the arrangement positions of the electrodes and their corresponding ground current data, and generating a position-charge quantity response curve as a measured triboelectric chemical spectrum of the liquid droplet; S3: comparing the measured triboelectric chemical spectrum with the standard triboelectric chemical spectra of multiple solution samples in a database to obtain multiple corresponding spectrum matching degrees; wherein the multiple solution samples have different chemical compositions, chemical valence states, and/or concentrations; and S4: identifying a solution sample in the database with the highest spectrum matching degree to the measured triboelectric chemical spectrum, and determining chemical composition, ion species, chemical valence state, and concentration information of the liquid droplet based on the chemical information of the solution sample.

In the analysis method of the present invention, the database is preconstructed by a method including: preparing a plurality of solution samples with specific chemical information according to analysis requirements, wherein the plurality of solution samples have different chemical compositions, chemical valence states, and/or concentrations; and conducting multiple liquid droplets triboelectric charging tests on each of the solution samples in accordance with the method described in steps S1 to S2, obtaining multiple sets of triboelectric chemical spectra for each solution sample, fitting the multiple sets of triboelectric chemical spectra into a standard triboelectric chemical spectrum for each solution sample, and constructing the database based on the specific chemical information and the standard triboelectric chemical spectra of the plurality of solution samples.

In the analysis method of the present invention, in step S3, the comparison items include the position, peak height, and peak width of characteristic peaks.

In the analysis method of the present invention, each of the electrodes comprises a material selected from the group consisting of copper film, aluminum film, and gold film; the plurality of electrodes is arranged in a linear array configuration, wherein the orientation of the linear array is inclined relative to a horizontal plane.

In the analysis method of the present invention, each of the electrodes is characterized by a thickness in a range of 0.1 μm to 1 mm, a length in a range of 1 mm to 100 cm, and a width in a range of 1 mm to 10 cm; the width direction of the electrodes is parallel to the direction of the linear array; the plurality of electrodes is arranged in a parallel and equally spaced configuration with a spacing in a range of 1 mm to 100 cm.

In the analysis method of the present invention, each of the electrodes has a cross-sectional shape perpendicular to the direction of the linear array, wherein the cross-sectional shape is one of a rectangle, a “V” shape, a “U” shape, and a circular ring.

In the analysis method of the present invention, the plurality of electrodes is arranged in a circumferential array configuration and fixed to a roller; the insulating film is disposed on an inner wall of the roller and in contact with the plurality of electrodes; the spectrometer further comprises a driving member configured to drive the roller to rotate about its central axis.

In the analysis method of the present invention, the insulating film is formed from one of polytetrafluoroethylene, perfluoroethylene propylene copolymer, nylon, and polymethyl methacrylate, and has a thickness in a range of 1 μm to 1 mm.

Solution of the present invention, for solving the above problem, is that the spectrometer is primarily used for the composition analysis of liquid samples, including elements, chemical valence states, and concentrations present in the liquid samples. The present invention utilizes a plurality of metal electrodes disposed beneath an insulating film; wherein different liquid droplets generate varying amounts of triboelectric charge at different positions as they slide over the solid film. The triboelectric charge at different positions is measured through the electrostatic induction effect between the metal electrodes and the surface triboelectric charges, thereby achieving a method for analyzing the chemical composition of liquid droplets using low-cost metal electrodes and an electrometer. Due to its simple structure and ease of fabrication, in addition to cost savings, the chemical composition analysis spectrometer also offers the advantages of low usage costs, portability and ease of maintenance.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating the principle of the chemical composition analysis spectrometer in the first embodiment of the present invention.

FIG. 2 is a partial cross-sectional view showing the insulator film and array electrodes fixed on the substrate in the first embodiment of the present invention.

FIG. 3 is a chemical composition analysis spectrum of different solutions provided in the first embodiment of the present invention.

FIG. 4 is a schematic diagram of the structure of a linear electrode array with a rectangular cross-section in the second embodiment of the present invention.

FIG. 5 is a schematic diagram of the structure of a linear electrode array with a “V”-shaped cross-section in the third embodiment of the present invention.

FIG. 6 is a schematic diagram of the structure of a linear electrode array with a semi-circular (U-shaped) cross-section in the third embodiment of the present invention.

FIG. 7 is a schematic diagram of the structure of a linear electrode array with a circular cross-section in the third embodiment of the present invention.

FIG. 8 is a schematic diagram of the circumferential electrode array on a roller in the fourth embodiment of the present invention.

FIG. 9 is a flowchart of the chemical composition analysis method in the fifth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### First Embodiment

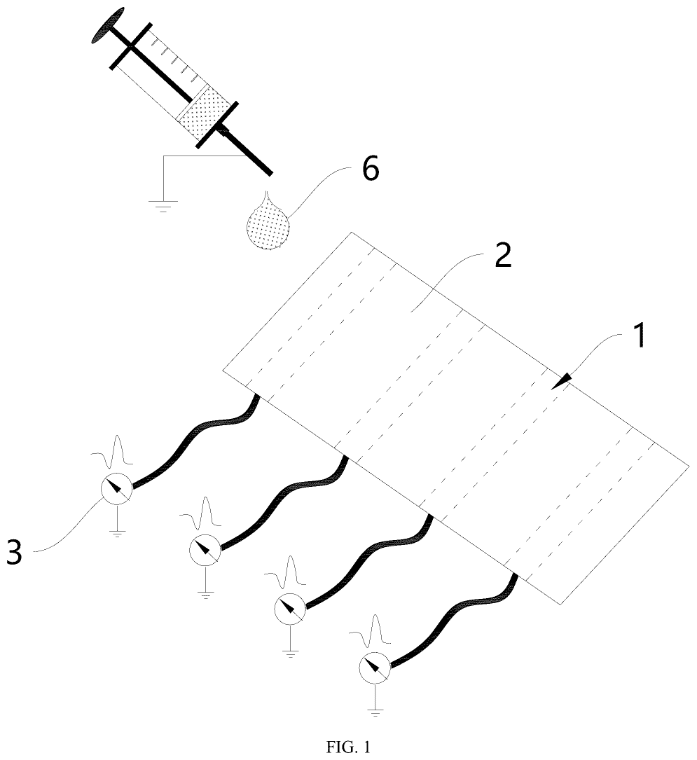

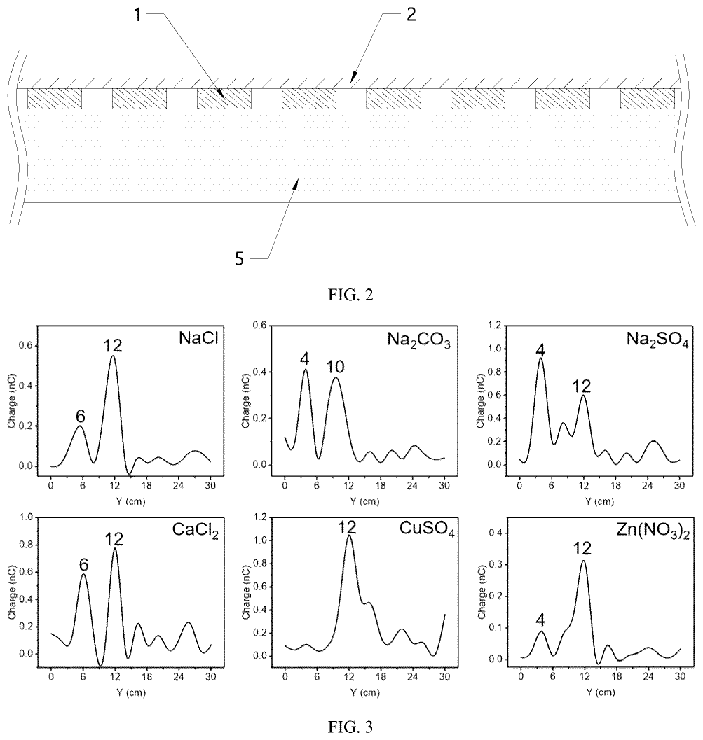

Referring to FIGS. 1 and 2, a chemical composition analysis spectrometer based on liquid friction is shown as an embodiment. The analysis spectrometer includes a plurality of electrodes 1, at least one layer of insulating film 2, a current collection module 3, and a data processing module.

The plurality of electrodes 1 is arranged in an array, each of the electrodes 1 includes a material selected from the group consisting of copper film, aluminum film, and gold film. The plurality of electrodes 1 is arranged in a linear array configuration, thereby enabling the number of electrodes 1 to be unlimited and arranged along the direction of the linear array according to requirements. Each of the electrodes 1 is characterized by a thickness in a range of 0.1 μm to 1 mm, a length in a range of 1 mm to 100 cm, and a width in a range of 1 mm to 10 cm. Additionally, the plurality of electrodes 1 may be fixed to a supporting substrate 5, wherein the shapes of the substrate 5 and the insulating film 2 may be adaptively configured according to the shape of the electrodes 1.

The insulating film 2 is disposed over the plurality of electrodes 1. In this configuration, when a liquid droplet 6 to be tested slides on an upper surface of the insulating film 2 along the arrangement direction of the plurality of electrodes 1, the liquid droplet 6 sequentially generates triboelectric charging with the surface of the insulating film 2 on each of the electrodes 1, thereby inducing a corresponding ground current in each of the electrodes 1.

The insulating film 2 may include any insulating solid material. In the present embodiment, the insulating film 2 is formed from one of polytetrafluoroethylene, perfluoroethylene propylene copolymer, nylon, and polymethyl methacrylate, and the insulating film has a thickness in a range of 1 μm to 1 mm.

The current collection module 3 is configured to collect ground current data generated by each of the electrodes 1. In the present embodiment, the current from the plurality of electrodes 1 may be measured using an electrometer. Additionally, the volume of the liquid droplet 6 to be tested may range from 0.1 microliters to 1 milliliter.

The data processing module is configured to implement three functions (a), (b), and (c), as described below.

Function (a): determining the triboelectric charge amount of the liquid droplet 6 at different positions on the insulating film 2 along the arrangement direction, based on the arrangement positions of the electrodes 1 and their corresponding ground current data, and generating a position-charge quantity response curve as a measured triboelectric chemical spectrum of the liquid droplet 6.

Referring to FIG. 3, triboelectric chemical composition spectra of various solutions obtained by the chemical composition analysis spectrometer, including NaCl solution, Na₂CO₃ solution, Na₂SO₄ solution, CaCl₂ solution, CuSO₄ solution, and Zn(NO₃)₂ solution. It is demonstrated that different ions exhibit unique characteristic peaks, thereby enabling the differentiation of different solutions. In the triboelectric chemical spectrum, the horizontal axis corresponds to the moving distance of the liquid droplet 6 along the distribution direction of the plurality of electrodes I on the insulating film 2, and the vertical axis corresponds to the triboelectric charge amount of the liquid at different positions on the solid surface.

Function (b): comparing the measured triboelectric chemical spectrum with the standard triboelectric chemical spectra of multiple solution samples in a database, and sequentially obtaining multiple corresponding spectrum matching degrees. In this function, the multiple solution samples have different chemical compositions, chemical valence states, and/or concentrations.

Specifically, the two solution samples differ in at least one of the following aspects of chemical information: chemical composition, chemical valence state, and concentration. The greater the variety and quantity of solution samples, the richer the constructed database, and the more accurate the results of spectrum matching degree calculations. For example, assuming that other chemical information and analysis conditions remain the same, within a certain concentration range, the database can be enriched by increasing the density of concentration sample data. For instance, a NaCl solution with a concentration range of 10% to 50% may have approximately 40 sample sets, which can be increased to 400 sample sets.

Function (c): identifying a solution sample in the database with the highest spectrum matching degree to the measured triboelectric chemical spectrum, and determining chemical composition, ion species, chemical valence state, and concentration information of the liquid droplet 6 based on the chemical information of the solution sample.

The comparison items include the position, peak height, and peak width of characteristic peaks. In some embodiments, different weights may be assigned to the comparison items of characteristic peak position, peak height, and peak width based on extensive experiments and empirical values, and the spectrum matching degrees may be obtained through weighted fusion.

In the present embodiment, the triboelectric characteristics between the liquid droplet 6 and the solid surface are utilized. When the liquid droplet 6 slides on the solid surface, the distribution of triboelectric charges along the sliding path is not uniform but follows a certain pattern. Different liquids exhibit different patterns of triboelectric charge distribution along the sliding path on the same solid surface. For example, some liquid droplets 6 generate a higher amount of triboelectric charge at the beginning of the sliding path and a lower amount at the end, while others generate a lower amount at the beginning and a higher amount at the end.

Based on this phenomenon, the present embodiment places metal electrodes 1 beneath the surface of the solid insulating film 2 and uses an electrometer to measure the ground current of each electrode. When the liquid droplet 6 to be tested slides over the solid surface, it generates triboelectric charging with the solid surface, inducing a ground current in the metal electrodes 1. By measuring the ground current of the metal electrodes I using the electrometer, the distribution of triboelectric charges on the solid surface can be obtained.

As described above, the spectrometer is primarily used for the composition analysis of liquid samples, including elements, chemical valence states, and concentrations present in the liquid samples. The present embodiment utilizes a plurality of metal electrodes 1 disposed beneath an insulating film 2, in which different liquid droplets 6 generate varying amounts of triboelectric charge at different positions as they slide over the solid film. The triboelectric charge at different positions is measured through the electrostatic induction effect between the metal electrodes 1 and the surface triboelectric charges, thereby achieving a method for analyzing the chemical composition of liquid droplets 6 using low-cost metal electrodes 1 and an electrometer. Due to its simple structure and ease of fabrication, in addition to cost savings, the triboelectric chemical composition analysis spectrometer also offers the advantages of low usage costs, portability and ease of maintenance. Second embodiment

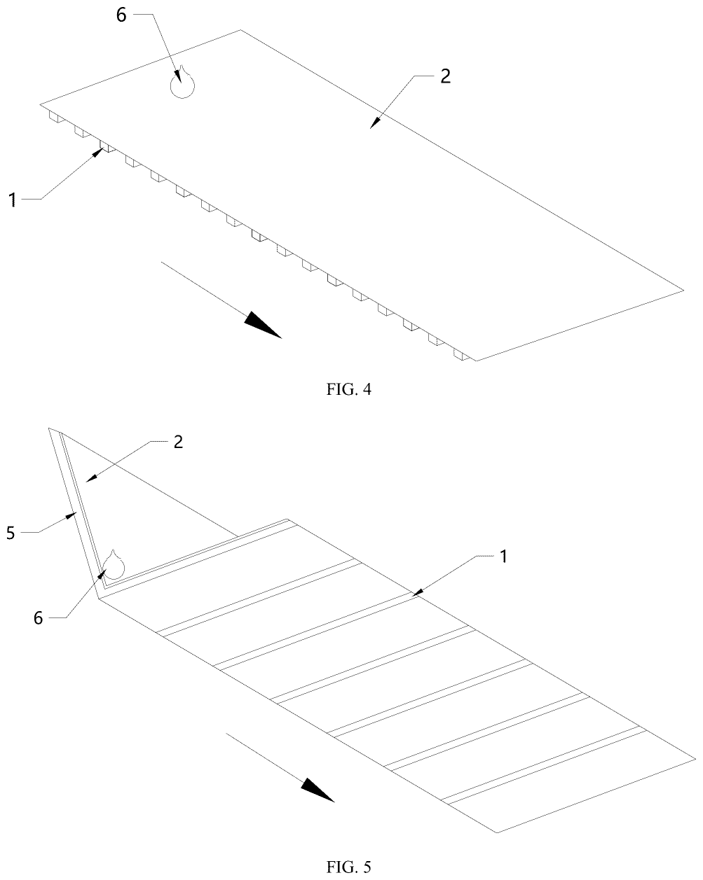

Referring to FIG. 4, a chemical composition analysis spectrometer based on liquid friction is shown as an embodiment. The analysis spectrometer is substantially similar to the first embodiment, except that the arrangement of the electrodes 1 is different.

The plurality of electrodes 1 is arranged in a linear array configuration, in which the orientation of the linear array is inclined relative to a horizontal plane. The tilt angle is an acute angle, which ensures that the liquid droplet 6 to be tested can roll off smoothly. The straight arrow at the bottom of the figure indicates the direction of the linear array. The cross-sectional shape of the electrodes 1 perpendicular to the direction of the linear array is rectangular, meaning that the substrate 5 as a whole may form an inclined rectangular plate, and the insulating film 2 covering the plurality of electrodes 1 may also conform to the shape of the substrate 5. In this way, the liquid droplet 6 can slide along the direction of the linear array of electrodes I on the inclined surface, moving from the highest point to the lowest point of the insulating film 2.

### Third Embodiment

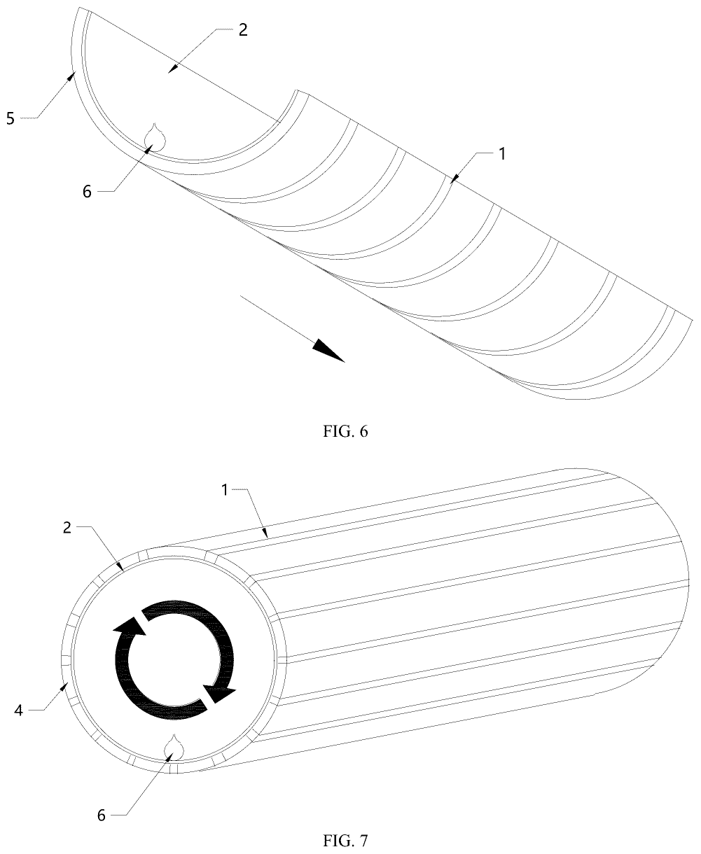

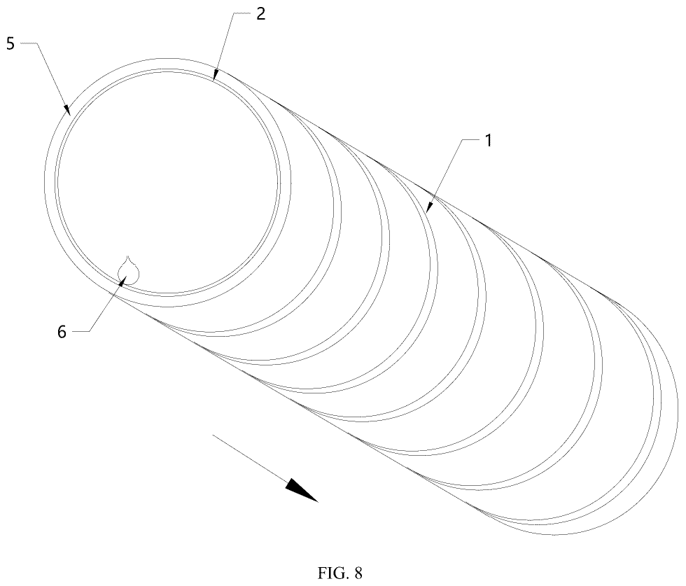

Referring to FIGS. 5, 6, and 7, a chemical composition analysis spectrometer based on liquid friction is shown as an embodiment. The analysis spectrometer is substantially similar to the first embodiment, except that the arrangement of the electrodes 1 is different.

The width direction of the electrodes 1 is parallel to the direction of the linear array. The plurality of electrodes 1 is arranged in a parallel and equally spaced configuration with a spacing in a range of 1 mm to 100 cm.

Each of the electrodes 1 has a cross-sectional shape perpendicular to the direction of the linear array, in which the cross-sectional shape is one of a rectangle, a “V” shape, a “U” shape, and a circular ring. In this manner, the substrate 5 and the insulating film 2 are configured to form a groove structure extending along the direction of the linear array, thereby enabling the liquid droplet 6 to slide more stably along the linear direction. Fourth embodiment

Referring to FIG. 8, a chemical composition analysis spectrometer based on liquid friction is shown as an embodiment. The analysis spectrometer is substantially similar to the first embodiment, with the differences lying in the arrangement of the electrodes 1 and the inclusion of a driving member.

The plurality of electrodes 1 is arranged in a circumferential array configuration and fixed to a roller 4. The insulating film 2 is disposed on an inner wall of the roller 4 and in contact with the plurality of electrodes 1. The driving member is configured to drive the roller 4 to rotate about its central axis.

In this embodiment, each of the electrodes 1 comprises a material selected from the group consisting of copper film, aluminum film, and gold film. An alternative arrangement of the plurality of electrodes 1 is also provided: a circumferential array distribution. Specifically, these electrodes 1 can be fixed to the circumferential side wall of the roller 4. For example, embedded in the roller 4, which the roller 4 is considered as the substrate 5 providing support.

In this embodiment, each of the electrodes 1 is characterized by a thickness in a range of 0.1 μm to 1 mm, a length in a range of 1 mm to 100 cm, and a width in a range of 1 mm to 10 cm. The insulating film 2 is formed from one of polytetrafluoroethylene, perfluoroethylene propylene copolymer, nylon, and polymethyl methacrylate, and has a thickness in a range of 1 μm to 1 mm.

Each electrode 1 is in the form of a straight strip parallel to the axis of the roller 4, and the inner side of the electrodes 1 along the radial direction of the roller 4 constitutes part of the inner wall of the roller 4. The insulating film 2 precisely covers the entire inner wall of the roller 4 and is in contact with the inner sides of the plurality of electrodes 1. In this way, an analysis spectrometer with the same principle as the aforementioned linear electrode 1 array but with a different structure and operating mode can be formed.

The end of the roller 4 can be coaxially fixed to the output shaft of a drive motor, thereby enabling the roller 4 to rotate about its own axis, with the circular double arrows in the figure indicating the direction of rotation of the roller 4. When the roller 4, carrying the electrodes 1 and the insulating film 2, rotates directionally, liquid droplets 6, due to gravity, remain on the insulating film 2 at the bottom wall of the roller 4. Thus, the entire device functions similarly to a treadmill or running wheel, with the liquid droplets 6 effectively running in place inside, allowing them to sequentially pass over each circumferentially distributed electrode 1 as the roller 4 rotates under external force, causing each electrode 1 to sequentially generate a current to ground.

It should be noted that the axis of the roller 4 in this setup is parallel to the horizontal plane, eliminating the need for tilting as in the aforementioned linear array, thereby potentially saving space in the analytical spectrometer. In some embodiments, multiple rollers 4 can be fixed in series, requiring only one drive motor to simultaneously rotate multiple rollers 4, allowing for simultaneous measurements of different droplets 6, effectively improving the efficiency of analytical work.

### Fifth Embodiment

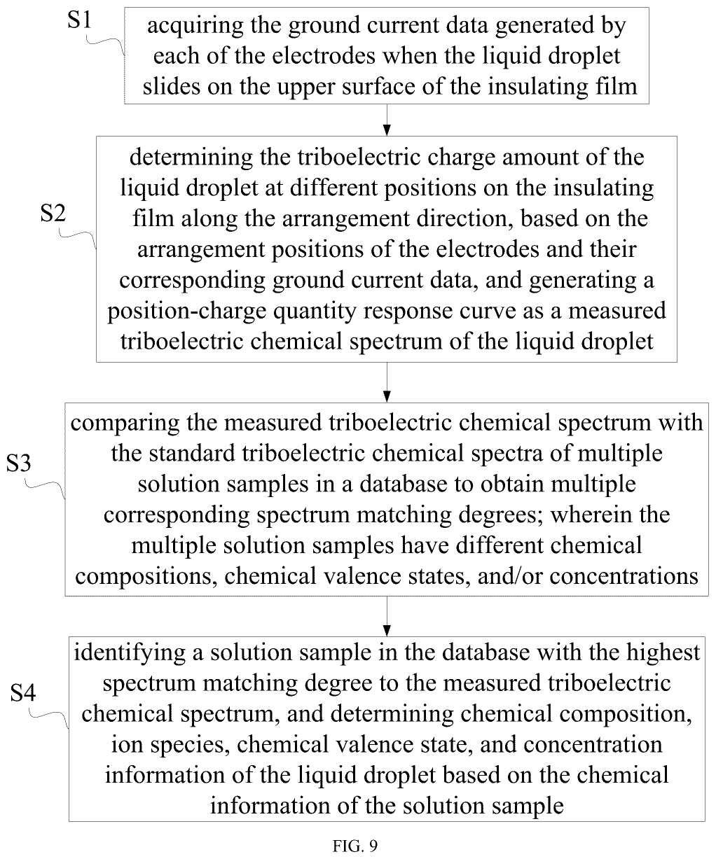

Referring to FIG. 9, a chemical composition analysis method based on liquid friction is shown as an embodiment. The analysis method is applied to the spectrometer according to the any of the first to fourth embodiments. The analysis method includes the following steps S1-S4.

Step S1: acquire the ground current data generated by each of the electrodes 1 when the liquid droplet 6 slides on the upper surface of the insulating film 2.

Step S2: determine the triboelectric charge amount of the liquid droplet 6 at different positions on the insulating film 2 along the arrangement direction, based on the arrangement positions of the electrodes 1 and their corresponding ground current data, and generating a position-charge quantity response curve as a measured triboelectric chemical spectrum of the liquid droplet 6.

Step S3: compare the measured triboelectric chemical spectrum with the standard triboelectric chemical spectra of multiple solution samples in a database to obtain multiple corresponding spectrum matching degrees; in which the multiple solution samples have different chemical compositions, chemical valence states, and/or concentrations.

Step S4: identify a solution sample in the database with the highest spectrum matching degree to the measured triboelectric chemical spectrum, and determine chemical composition, ion species, chemical valence state, and concentration information of the liquid droplet 6 based on the chemical information of the solution sample.

In some embodiments, in step S3, the comparison items comprise the position, peak height, and peak width of characteristic peaks. Each of the electrodes 1 includes a material selected from the group consisting of copper film, aluminum film, and gold film. The plurality of electrodes 1 is arranged in a linear array configuration, in which the orientation of the linear array is inclined relative to a horizontal plane.

In some embodiments, each of the electrodes 1 has a cross-sectional shape perpendicular to the direction of the linear array, in which the cross-sectional shape is one of a rectangle, a “V” shape, a “U” shape, and a circular ring.

In some embodiments, the plurality of electrodes 1 is arranged in a circumferential array configuration and fixed to a roller 4; the insulating film 2 is disposed on an inner wall of the roller 4 and in contact with the plurality of electrodes 1; the spectrometer further comprises a driving member configured to drive the roller 4 to rotate about its central axis.

In other embodiment, each of the electrodes 1 is characterized by a thickness in a range of 0.1 μm to 1 mm, a length in a range of 1 mm to 100 cm, and a width in a range of 1 mm to 10 cm. The width direction of the electrodes 1 is parallel to the direction of the linear array. The plurality of electrodes 1 is arranged in a parallel and equally spaced configuration with a spacing in a range of 1 mm to 100 cm. The insulating film 2 is formed from one of polytetrafluoroethylene, perfluoroethylene propylene copolymer, nylon, and polymethyl methacrylate, and has a thickness in a range of 1 μm to 1 mm.

### Sixth Embodiment

A chemical composition analysis method based on liquid friction is shown as an embodiment. The analysis method incorporates additional steps based on the procedures outlined in the fifth embodiment. The database is preconstructed by a construction method. The construction method includes step (1) and step (2).

Step (1): prepare a plurality of solution samples with specific chemical information according to analysis requirements, in which the plurality of solution samples have different chemical compositions, chemical valence states, and/or concentrations.

Step (2): conduct multiple liquid droplets 6 triboelectric charging tests on each of the solution samples in accordance with the method described in steps S1 to S2, obtaining multiple sets of triboelectric chemical spectra for each solution sample, fitting the multiple sets of triboelectric chemical spectra into a standard triboelectric chemical spectrum for each solution sample, and constructing the database based on the specific chemical information and the standard triboelectric chemical spectra of the plurality of solution samples.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A chemical composition analysis spectrometer based on liquid friction, comprising:
a plurality of electrodes arranged in an array;
at least one layer of insulating film disposed over the plurality of electrodes, wherein when a liquid droplet to be tested slides on an upper surface of the insulating film along the arrangement direction of the plurality of electrodes, the liquid droplet sequentially generates triboelectric charging with the surface of the insulating film on each of the electrodes, thereby inducing a corresponding ground current in each of the electrodes;
a current collection module configured to collect ground current data generated by each of the electrodes; and
a data processing module configured to:
(a) determine the triboelectric charge amount of the liquid droplet at different positions on the insulating film along the arrangement direction, based on the arrangement positions of the electrodes and their corresponding ground current data, and generate a position-charge quantity response curve as a measured triboelectric chemical spectrum of the liquid droplet;
(b) compare the measured triboelectric chemical spectrum with the standard triboelectric chemical spectra of multiple solution samples in a database, and sequentially obtain multiple corresponding spectrum matching degrees; wherein the multiple solution samples have different chemical compositions, chemical valence states, and/or concentrations; and
(c) identify a solution sample in the database with the highest spectrum matching degree to the measured triboelectric chemical spectrum, and determine chemical composition, ion species, chemical valence state, and concentration information of the liquid droplet based on the chemical information of the solution sample.

2. The spectrometer according to claim 1, wherein each of the electrodes comprises a material selected from the group consisting of copper film, aluminum film, and gold film.

3. The spectrometer according to claim 1, wherein the plurality of electrodes is arranged in a linear array configuration, wherein the orientation of the linear array is inclined relative to a horizontal plane.

4. The spectrometer according to claim 1, wherein each of the electrodes is characterized by a thickness in a range of 0.1 μm to 1 mm, a length in a range of 1 mm to 100 cm, and a width in a range of 1 mm to 10 cm.

5. The spectrometer according to claim 1, wherein the width direction of the electrodes is parallel to the direction of the linear array; the plurality of electrodes is arranged in a parallel and equally spaced configuration with a spacing in a range of 1 mm to 100 cm.

6. The spectrometer according to claim 5, wherein each of the electrodes has a cross-sectional shape perpendicular to the direction of the linear array, wherein the cross-sectional shape is one of a rectangle, a “V” shape, a “U” shape, and a circular ring.

7. The spectrometer according to claim 1, wherein the plurality of electrodes is arranged in a circumferential array configuration and fixed to a roller; the insulating film is disposed on an inner wall of the roller and in contact with the plurality of electrodes.

8. The spectrometer according to claim 7, wherein the spectrometer further comprising:
a driving member configured to drive the roller to rotate about its central axis.

9. The spectrometer according to claim 1, wherein the insulating film is formed from one of polytetrafluoroethylene, perfluoroethylene propylene copolymer, nylon, and polymethyl methacrylate, and has a thickness in a range of 1 μm to 1 mm.

10. A chemical composition analysis spectrometer based on liquid friction, comprising:
a plurality of electrodes arranged in an array; each of the electrodes comprises a material selected from the group consisting of copper film, aluminum film, and gold film;
the plurality of electrodes is arranged in a circumferential array configuration and fixed to a roller;
at least one layer of insulating film disposed over the plurality of electrodes, wherein when a liquid droplet to be tested slides on an upper surface of the insulating film along the arrangement direction of the plurality of electrodes, the liquid droplet sequentially generates triboelectric charging with the surface of the insulating film on each of the electrodes, thereby inducing a corresponding ground current in each of the electrodes; the insulating film is disposed on an inner wall of the roller and in contact with the plurality of electrodes;
a driving member configured to drive the roller to rotate about its central axis;
a current collection module configured to collect ground current data generated by each of the electrodes; and
a data processing module configured to:
(a) determine the triboelectric charge amount of the liquid droplet at different positions on the insulating film along the arrangement direction, based on the arrangement positions of the electrodes and their corresponding ground current data, and generate a position-charge quantity response curve as a measured triboelectric chemical spectrum of the liquid droplet;
(b) compare the measured triboelectric chemical spectrum with the standard triboelectric chemical spectra of multiple solution samples in a database, and sequentially obtain multiple corresponding spectrum matching degrees; wherein the multiple solution samples have different chemical compositions, chemical valence states, and/or concentrations; and
(c) identify a solution sample in the database with the highest spectrum matching degree to the measured triboelectric chemical spectrum, and determine chemical composition, ion species, chemical valence state, and concentration information of the liquid droplet based on the chemical information of the solution sample.

11. The spectrometer according to claim 10, wherein the insulating film is formed from one of polytetrafluoroethylene, perfluoroethylene propylene copolymer, nylon, and polymethyl methacrylate, and has a thickness in a range of 1 μm to 1 mm.

12. The spectrometer according to claim 10, wherein each of the electrodes is characterized by a thickness in a range of 0.1 μm to 1 mm, a length in a range of 1 mm to 100 cm, and a width in a range of 1 mm to 10 cm.

13. A chemical composition analysis method based on liquid friction, characterized in that the method is applied to the spectrometer according to claim 1; the analysis method comprises the following steps:
S1: acquiring the ground current data generated by each of the electrodes when the liquid droplet slides on the upper surface of the insulating film;
S2: determining the triboelectric charge amount of the liquid droplet at different positions on the insulating film along the arrangement direction, based on the arrangement positions of the electrodes and their corresponding ground current data, and generating a position-charge quantity response curve as a measured triboelectric chemical spectrum of the liquid droplet;
S3: comparing the measured triboelectric chemical spectrum with the standard triboelectric chemical spectra of multiple solution samples in a database to obtain multiple corresponding spectrum matching degrees; wherein the multiple solution samples have different chemical compositions, chemical valence states, and/or concentrations; and
S4: identifying a solution sample in the database with the highest spectrum matching degree to the measured triboelectric chemical spectrum, and determining chemical composition, ion species, chemical valence state, and concentration information of the liquid droplet based on the chemical information of the solution sample.

14. The analysis method according to claim 13, wherein the database is preconstructed by a method comprising:
preparing a plurality of solution samples with specific chemical information according to analysis requirements, wherein the plurality of solution samples have different chemical compositions, chemical valence states, and/or concentrations; and
conducting multiple liquid droplets triboelectric charging tests on each of the solution samples in accordance with the method described in steps S1 to S2, obtaining multiple sets of triboelectric chemical spectra for each solution sample, fitting the multiple sets of triboelectric chemical spectra into a standard triboelectric chemical spectrum for each solution sample, and constructing the database based on the specific chemical information and the standard triboelectric chemical spectra of the plurality of solution samples.

15. The analysis method according to claim 13, wherein in step S3, the comparison items comprise the position, peak height, and peak width of characteristic peaks.

16. The analysis method according to claim 13, wherein each of the electrodes comprises a material selected from the group consisting of copper film, aluminum film, and gold film; the plurality of electrodes is arranged in a linear array configuration, wherein the orientation of the linear array is inclined relative to a horizontal plane.

17. The analysis method according to claim 13, wherein each of the electrodes is characterized by a thickness in a range of 0.1 μm to 1 mm, a length in a range of 1 mm to 100 cm, and a width in a range of 1 mm to 10 cm; the width direction of the electrodes is parallel to the direction of the linear array; the plurality of electrodes is arranged in a parallel and equally spaced configuration with a spacing in a range of 1 mm to 100 cm.

18. The analysis method according to claim 13, wherein each of the electrodes has a cross-sectional shape perpendicular to the direction of the linear array, wherein the cross-sectional shape is one of a rectangle, a “V” shape, a “U” shape, and a circular ring.

19. The analysis method according to claim 13, wherein the plurality of electrodes is arranged in a circumferential array configuration and fixed to a roller; the insulating film is disposed on an inner wall of the roller and in contact with the plurality of electrodes;
the spectrometer further comprises a driving member configured to drive the roller to rotate about its central axis.

20. The analysis method according to claim 13, wherein the insulating film is formed from one of polytetrafluoroethylene, perfluoroethylene propylene copolymer, nylon, and polymethyl methacrylate, and has a thickness in a range of 1 μm to 1 mm.
